(19) United States
(12) Patent Application Publication
(10) Pub. No.: US 2010/0288616 A1
(43) Pub. Date: Nov. 18, 2010

(54) Adjustable pressure gauged switch for electric valve-less pumps

(76) Inventors: Wang-Ken Lee, Marietta, GA (US); Yi-Wei Lin, Yonghe City (TW)

Correspondence Address: Muncy, Geissler, Olds & Lowe, PLLC, 4000 Legato Road, Suite 310, FAIRFAX, VA, 22033, US

(21) Appl. No.: 11/790,879

(22) Filed: Apr. 27, 2007

(51) Int. Cl. H01H 35/24

(52) U.S. Cl. 200/81 R

(57) ABSTRACT

An adjustable pressure gauged switch for electric valve-less pumps, including a block, a switch, a pressure reaction module, a base and a pressure gauge, wherein the block is able to contain the pressure reaction module. A switch is connected to a lower end of the block, and the base is connected to a rear end of the block. The pressure reaction module is used to adjust setting fluid pressure passing through the base, thereby activate or deactivate a microswitch. A check valve is configured interior of the base close to a passage inlet end, which is able to prevent backflow of fluid passing through the base inlet causing a pressure drop and restarting the microswitch.

### BACKGROUND OF THE INVENTION

### (a) Field of the Invention

The present invention relates to fluid pressure switches, and more particularly to an adjustable pressure gauged switch for electric valve-less pumps, wherein a check valve is configured within a passage, thereby prohibiting fluid backflow from producing a pressure drop and actuating a pressure switch. Moreover, inner and outer springs provided with adjustment functionality act in coordination with a pressure gauge to accurately anticipate relationship between a microswitch and fluid pressure.

(b) Description of the Prior Art

FIG. 1 shows a fluid pressure switch 10 of prior art, primarily comprising a base 100, interior of which is provided with a passage 101 that penetrates from front to rear of the base 100. A diaphragm mounting hole 102 is defined in one side of and perpendicular to the passage 101. The diaphragm mounting hole 102 enables a diaphragm 103 to be disposed therein; a side of the diaphragm 103 is fitted with a seat 105, and a spring 104 is located on a back end of the rod 106. Another end of the spring 104 is mounted against the switch 107, and a rod 106 extends from an end of the seat 105. The rod 106 drives a bar 108 located within a switch 107 when displaced, thereby causing the bar 108 to activate or deactivate a microswitch 109.

Accordingly, when fluid pressure within the passage 101 is greater than a predetermined force of the spring 104, then the fluid pushes back the diaphragm 103, thereby causing the rod 106 to drive the bar 108 and activate the microswitch 109, thus stopping operation of a pump. When the fluid pressure drops below a minimum set pressure, then the diaphragm 103 is again pushed by the spring 104 and restored to its original position, thereby causing contact with the microswitch 109 to be deactivated, which simultaneously starts the pump to continue operation.

The aforementioned fluid pressure switch 10 is used extensively in liquid dispensing equipments, such as carwash water guns, chemical sprayers. Moreover, the majority of fluid pressure switches are installed at a position remote from the handle of a spray gun to achieve convenience of control of switch on and off. When the spray gun is opened and spraying out fluid, a pressure drop between the pressure switch and the spray gun starts the pump, which then pumps fluid (such as water, cleaning agent, and so on) stored in a fluid container through a hose and into spray gun. The fluid then passes through an outlet of the spray gun and sent out liquid through nozzle. When the spray gun is closed, and the pressure rises to a predetermined value, then the pump is shut off.

According to the aforementioned description, it can be appreciated that the primary objective of the fluid pressure switch 10 is to control switching on and switching off of the power supply to the pump. However, the aforementioned fluid pressure switch has the following shortcomings:

1. Because the passage 101 is a normally open passage that penetrates from front to rear of the base 100, thus, there is no problem when the pump connected to an inlet end of the passage is a valved pump. However, when the pump connected to the inlet end of the passage is a valve-less pump, because the valve-less pump produces a backflow when it stops operating, which is followed by a lowering of fluid pressure at the pump outlet end. Thus, repeated starting and stopping of the pump that causing the output fluid pressure fluctuate, hence, fluid pressure control function correspondingly declines.

2. Because of the limitation in the pumps suitable for use with the aforementioned fluid pressure switch of prior art, thus, application of the fluid pressure switch is correspondingly limited.

3. The diaphragm 103 that responds to the fluid pressure is only supported by the single spring 104, and elastic response of the spring 104 is affected by elastic fatigue or the spring 104 easily resonates after a long period of use. The response capability of the diaphragm 103 caused correspondingly decline, which results in another factor affecting an unstable output fluid pressure.

4. There is no pressure gauge available to refer to when adjusting the pressure, thus, fluid pressure cannot be accurately adjusted to a desired pressure.

In light of the above, after a long period of research and improvements, the inventor of the present invention herein discloses a new and advanced configuration to resolve and surmount existent technical difficulties to eliminate the aforementioned shortcomings of prior art.

### SUMMARY OF THE INVENTION

Accordingly, a primary objective of the present invention is to provide an adjustable pressure gauged switch for electric valve-less pumps, wherein a check valve is configured in the inlet end passage, thereby providing means for adjusting fluid pressure that is not limited by type of pumps, and rendering the present invention applicable for use in valve-less pumps.

Another objective of the present invention is to provide the adjustable pressure gauged switch for electric valve-less pumps with inner and outer bilayer springs that serve to counterbalance fluid pressure, and disposition of the inner spring and the outer spring not only extends operational life of the springs, but also eliminates the shortcoming of occasional resonance of a single spring, thereby achieving better pressure reaction and a reliable switch action.

Yet another objective of the present invention is to provide the adjustable pressure gauged switch for electric valve-less pumps with pressure adjusting screw and a pressure gauge that enable pressure to be adjusted accurately according to the demand, thereby substantially improving applications of the present invention.

Yet another objective of the present invention is to enable the adjustable pressure gauged switch to be installed close to a pump and remote to a spray gun or faucet.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a cross-sectional view of a fluid pressure gauge of prior art.

FIG. 2 shows an assembled elevational view according to the present invention.

FIG. 3 shows an exploded elevational view according to the present invention.

FIG. 4 shows an assembled cross-sectional view according to the present invention.

FIG. 5 shows a schematic view depicting movement of an arm of a switch according to the present invention.

FIG. 6 shows a schematic view of an embodiment according to the present invention.

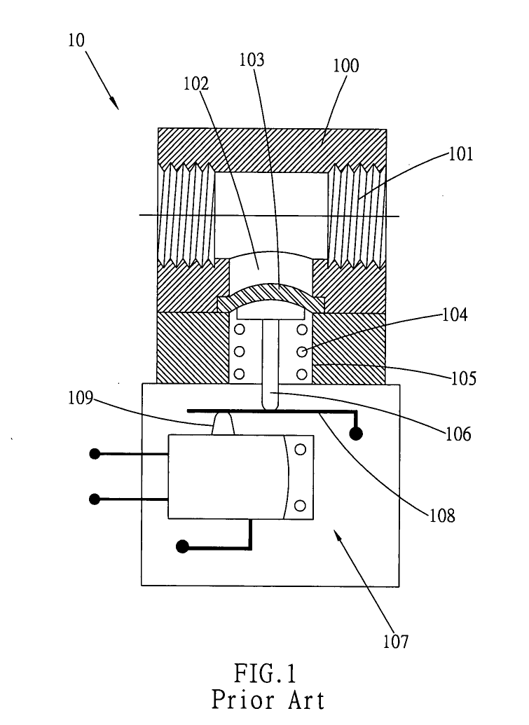

### DETAILED DESCRIPTION OF THE PREFERRED EMBODIMENTS

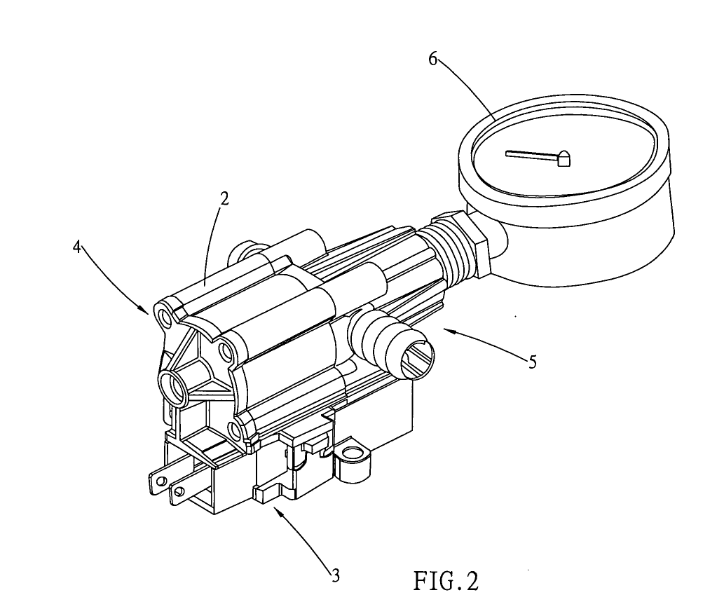

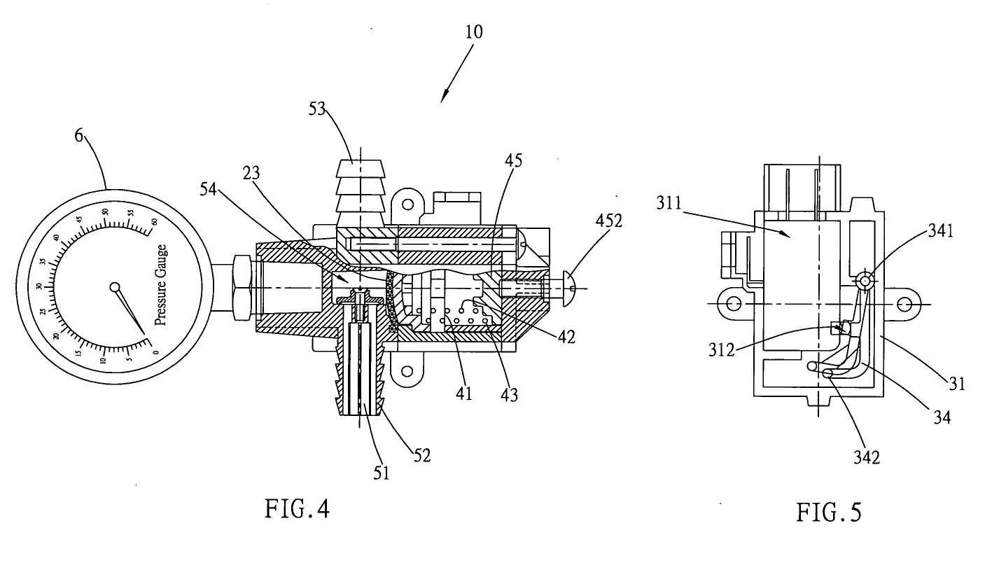

Referring to FIGS. 2, 3 and 4, which show a fluid pressure switch 10 of the present invention, comprising a block 2, a switch 3, a pressure reaction module 4, a base 5 and a pressure gauge 6, wherein:

An axial passage 21 is defined central of and penetrates from front to rear of the aforementioned block 2, and an axial hole 22 is defined in a lower end of the axial passage 21. Moreover, a diaphragm 23 is located at an opening in an end of the axial passage 21.

Referring to FIG. 5, wherein the switch 3 is disposed at a lower end of the block 2, and comprises a housing 31, interior of which is provided with a main space 32 and a secondary space 33. The main space 32 enables a microswitch 311 to be disposed therein, and the secondary space 33 enables an arm 34 to be inserted therein. A gate 331 is further defined in the secondary space 33 installed with the arm 34, and a hole (not shown in the drawings) is defined in a lower end of the gate 331. A lower end of a shaft 341 formed at an end of the arm 34 serves as a rotating pivot that inserts into the insert groove. Moreover, functional coordination between the shaft 341 and the gate 331 enables the arm 34 to moderately sway. A round point 342 is formed at another end of the arm 34, and pushing of the round point 342 of the arm 34 activates a button 312 of the microswitch 311, thereby controlling on and off of a pump.

The pressure reaction module 4 comprises a lower seat 41, an inner spring 42, an outer spring 43, an upper seat 44 and a side cover 45. The lower seat 41, the inner spring 42, the outer spring 43 and the upper seat 44 are all disposed within the axial passage 21 of the block 2, and the side cover 45 is then joined to a side of the block 2 to complete assembly of the pressure reaction module 4. An internal thread 451 is defined central of the side cover 45, thereby enabling a pressure adjusting screw 452 to be screwed therein. The pressure adjusting screw 452 is directed towards an recess 441 defined in an outer side of the upper seat 44, and is used to adjust length of the inner spring 42 and the outer spring 43, thereby varying applied force to the diaphragm 23. A linkage 411 extends from a lower end of the aforementioned lower seat 41, and a mounting hole 412 defined in an end of the linkage 411 enables the round point 342 of the arm 34 to be mounted therein, thereby enabling the linkage 411 to activate the microswitch 311 after the lower seat 41 has been pushed back by the diaphragm 23.

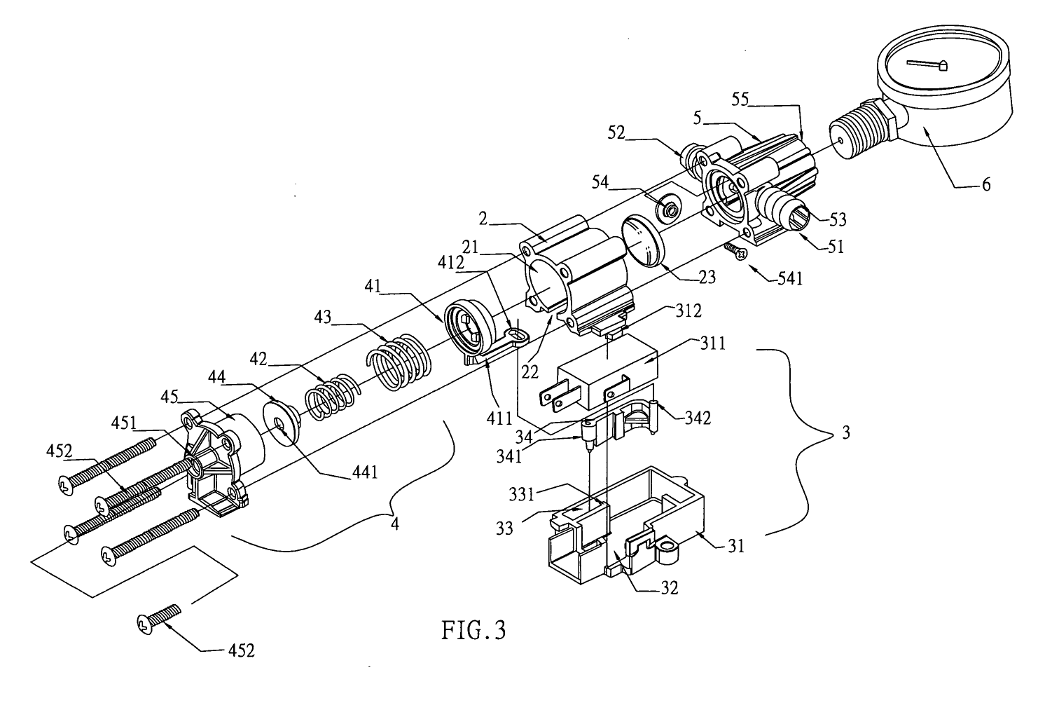

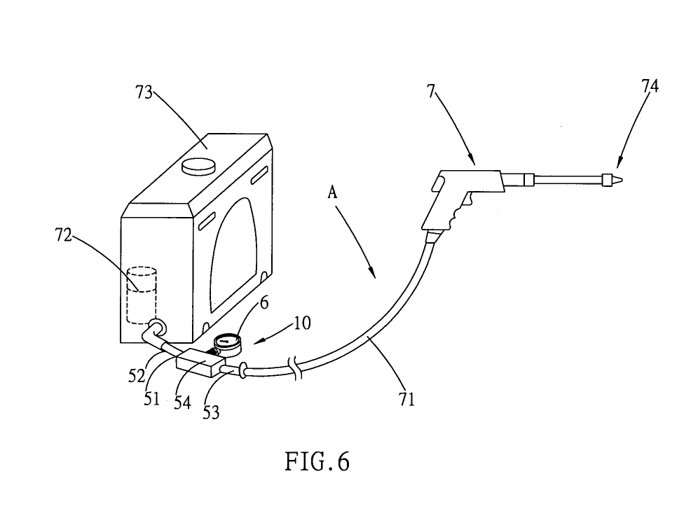

The base 5 is located on a side of the block 2 and connectively disposed on one end of the diaphragm 23 so that the diaphragm 23 is positioned between the block 2 and the base 5 when assembled. A radially disposed passage 51 is defined in the base 5. An end of the passage 51 is an inlet 52, and another end is an outlet 53, and hoses can be respectively connected to the inlet 52 and the outlet 53. A check valve 54 and a screw 541 used to fix the check valve 54 are located interior of the passage 51 close to a tail end of the inlet 52, wherein the check valve 54 controls fluid flow to only enable the fluid to flow in and not flow back. A side hole of the passage 51 enables guiding fluid flow into the pressure gauge 6, and a side passage 55 is provided thereat to enable the pressure gauge 6 to be assembled thereon. According to the aforementioned configuration, referring to FIGS. 6 and 3, wherein, as an example of use, FIG. 6 depicts application of the present invention in conjunction with a water gun handle valve 7, and shows a hose 71 connecting the outlet 53 to a liquid supply 73 of a pump 72. When the handle valve 7 is opened, then pressure between the fluid pressure switch 10 and the handle valve 7 drops, thereby actuating the fluid pressure switch 10, which causes the pump 72 to start operating and enables fluid to be transported into the passage 51 through the pressure switch 10, whereupon the pressure gauge 6 displays pressure of the fluid. The pump 72 continues operating to enable the fluid to be sprayed out through a nozzle 74 at a front end of the water gun handle valve 7. Closing the valve 7 stops the fluid from spraying out from the nozzle 74, at which time the pump continues to operate, thereby causing fluid pressure interior of the passage 51 to rise and exceed control functionality of the inner spring 42 and the outer spring 43, which forces the diaphragm 23 to push back the lower seat 41, thus causing the linkage 411 to drive the arm 34 and activate the button 312 of the microswitch 311, thereby causing the pump 72 to stop operating. As soon as fluid pressure interior of the passage 51 is lower than the control functionality of the inner spring 42 and the outer spring 43, then reverse pushing of the inner spring 42 and the outer spring 43 causes the lower seat 41 to move forward, thereby enabling the diaphragm 23 to return to its original position, whereupon the driving action of the arm 34 is released and pressure on the button 312 of the microswitch 311 relieved, thus enabling the pump 72 to continue operating, and maintaining a stable fluid output pressure.

Referring to FIGS. 3, 4 and 5, because of disposition of the check valve 54 and the screw 541 used to fix the check valve 54 interior of the passage 51, thus, fluid is only able to flow in and backflow is prevented, thereby forming a fluid area A between the check valve 54 and the valve 7. Pressure of the fluid area A controls switching on and switching off of a power supply to the pump 72, and actuating or closing of the valve 7 enables release or stopping release of the fluid through the nozzle 74. Hence, when using a valve-less pump, backflow of the fluid will not occur when the pump stops operating, thus, the present invention is equally applicable for use in both valved pumps and valve-less pumps.

In addition, it can be clearly seen from the drawings that the present invention employs an elastic support member jointly formed from the inner spring 42 and the outer spring 43, and uses disposition of the inner and outer springs 42, 43 to increase elastic response and sensitivity, moreover, is able to reduce inaccurate activation of the microswitch 311 resulting from fluid pressure and resonance of related component members.

Referring again to FIG. 6, wherein the fluid pressure switch 10 is configured close to the pump 72 in order to omit the need for electrical control wiring, however, the pressure gauge 6 must be exposed in order for a user to see. The inlet 52 and the outlet 53 are in series connected in the liquid pressure output path, thereby effectively detecting liquid pressure, and controlling on and off of the pump 72.

Hence, structural configuration of the present invention provides a fluid pressure switch with more stable and accurate control functionality. Moreover, because there are no restrictions on the pump used in conjunction with the present invention, thus, application range of the present invention is more extensive, including application in electric spray machines, car washes, drinking machines, medical industry, chemical industry, and so on.

In conclusion, the adjustable pressure gauged switch for electric valve-less pumps of the present invention uses the check valve 54 configured interior of the passage 51, the inner and outer bilayer springs 42, 43 located on the end of the diaphragm 23 and the additionally attached pressure gauge 6 to enable accurate pressure adjustment. Moreover, the present invention is applicable for use in both valved pumps and valve-less pumps, and achieves substantially accurate fluid output pressure. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An adjustable pressure gauged switch for electric valve-less pumps, comprising a block, a switch, a pressure reaction module and a base, wherein the block is able to contain the pressure reaction module, the switch is connected to one end of the block, and the base is connected to another end, a diaphragm is disposed between the base and the pressure reaction module; wherein a check valve is located at an inlet interior of the base.

2. The adjustable pressure gauged switch for electric valve-less pumps according to claim 1, wherein the pressure reaction module comprises seats and springs, and the springs further comprise an inner spring and an outer spring.

3. The adjustable pressure gauged switch for electric valve-less pumps according to claim 2, wherein control function of a pressure adjusting screw effects abutting against an outer side end of the seat to adjust setting fluid pressures therewith.

4. The adjustable pressure gauged switch for electric valve-less pumps according to claim 1, wherein a side passage is defined in a side of a passage of the base, and is used to connect to a pressure gauge.

5. The adjustable pressure gauged switch for electric valve-less pumps according to claim 1, wherein the switch is provided with a space that enables a microswitch to be disposed therein, and a gate, which enables an arm to freely rotate after inserting therein, is further defined in the switch.

6. The adjustable pressure gauged switch for electric valve-less pumps according to claim 5, wherein a shaft formed at one end of the arm is inserted into the gate, and another end of the arm upwardly forms a round point that enables a linkage located at a lower end of the seat to effect a driving action therewith.

7. The adjustable pressure gauged switch for electric valve-less pumps according to claims 5, wherein a counteraction portion is formed on a middle section of the arm.

8. The adjustable pressure gauged switch for electric valve-less pumps according to claims 6, wherein a counteraction portion is formed on a middle section of the arm.

9. The adjustable pressure gauged switch for electric valve-less pumps according to claim 1, wherein the pressure switch is configured close to a pump.

10. An adjustable pressure gauged switch for electric valve-less pumps, comprising a block, a switch, a pressure reaction module and a base, wherein the block is able to contain the pressure reaction module, the switch is connected to an end of the block, and the base is connected to another end, a diaphragm is disposed between the base and the pressure reaction module; wherein the pressure reaction module comprises seats and springs, and the springs further comprise an inner spring and an outer spring.

11. The adjustable pressure gauged switch for electric valve-less pumps according to claim 10, wherein control function of a pressure adjusting screw effects abutting against an outer side end of the seat to adjust setting fluid pressures therewith.

12. The adjustable pressure gauged switch for electric valve-less pumps according to claim 10, wherein a side passage is defined in a side of a passage of the base, and is used to connect to a pressure gauge.

13. The adjustable pressure gauged switch for electric valve-less pumps according to claim 10, wherein the switch is provided with a space that enables a microswitch to be disposed therein, and a gate, which enables an arm to freely rotate after inserting therein, is further defined in the switch.

14. The adjustable pressure gauged switch for electric valve-less pumps according to claim 13, wherein a shaft formed at one end of the arm inserts into the gate, and another end of the arm upwardly forms a round point that enables a linkage located at a lower end of the seat to effect a driving action therewith.

15. The adjustable pressure gauged switch for electric valve-less pumps according to claim 14, wherein movement of the arm is effected by pulling or pushing actions of the linkage of the lower end of the seat.

16. The adjustable pressure gauged switch for electric valve-less pumps according to claim 14, wherein a counteraction portion is formed on a middle section of the arm.

17. An adjustable pressure gauged switch for electric valve-less pumps, comprising a block, a switch, a pressure reaction module and a base, wherein the block is able to contain the pressure reaction module, the switch is connected to one end of the block, and the base is connected to another end, a diaphragm is disposed between the base and the pressure reaction module; wherein the switch is provided with a space that enables a microswitch to be disposed therein, and a gate, which enables an arm to freely rotate after inserting therein, is further defined in the switch.

18. The adjustable pressure gauged switch for electric valve-less pumps according to claim 17, wherein a shaft formed at one end of the arm is inserted into the gate, and another end of the arm upwardly forms a round point that enables a linkage located at a lower end of the seat to effect a driving action therewith.

19. The adjustable pressure gauged switch for electric valve-less pumps according to claim 18, wherein movement of the arm is effected by pulling or pushing actions of the linkage of the lower end of the seat.

20. The adjustable pressure gauged switch for electric valve-less pumps according to claim 18, wherein a counteraction portion is formed on a middle section of the arm.
